(19) United States
(12) Patent Application Publication
(10) Pub. No.: US 2009/0284044 A1
(43) Pub. Date: Nov. 19, 2009

(54) AIR GUIDE DEVICE

(75) Inventors: Bela Molnar, Ehningen (DE); Heinz Soja, Weil Der Stadt (DE)

Correspondence Address: RATNERPRESTIA, P.O. BOX 980, VALLEY FORGE, PA, 19482, US

(73) Assignee: DR. ING. H.C.F. PORSCHE AG, STUTTGART (DE)

(21) Appl. No.: 12/466,718

(22) Filed: May 15, 2009

(30) Foreign Application Priority Data
May 16, 2008 (DE) 10 2008 024 895.9

(51) Int. Cl. B62D 35/00; B62D 37/02

(52) U.S. Cl. 296/181.5

(57) ABSTRACT

An air guide device, especially an extendable and retractable rear spoiler on a motor vehicle, that includes an adjustable air guide element and at least one, also adjustable, flow element designed as an underflow guard. A sealing element, which seals off an intermediate space between the air guide element and the flow element at least when the air guide element is fully extended, is provided either on the flow guide element or on the flow element.

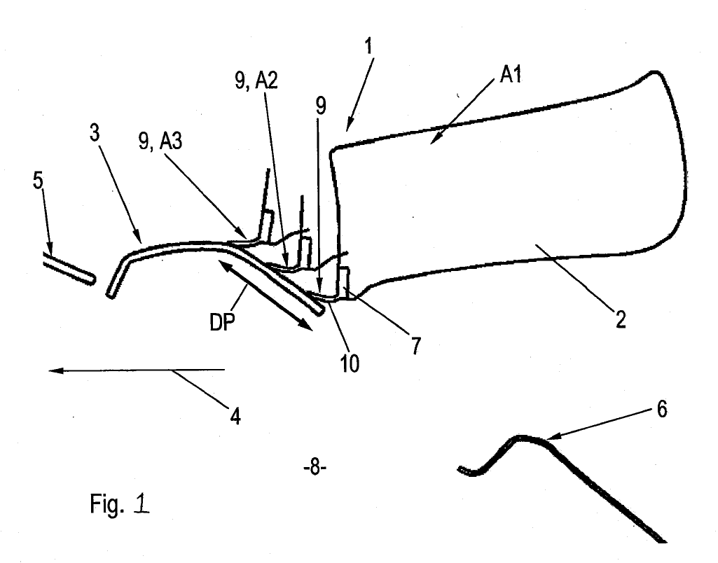

The present invention pertains to an air guide device, especially to an extendable and retractable rear spoiler on a motor vehicle, according to the introductory clause of Claim 1. The invention also pertains to a motor vehicle equipped with an air guide device of this type.

An air guide device of the general type in question is known from, for example, EP 0 226 778 A2, which comprises an air guide element and a plate-shaped closure part, designed as an underflow guard. The closure part is designed as an integral part of the air guide element and is thus adjusted together with the guide element between a rest position and an operating position.

Another air guide device, which is arranged in a rear area of a motor vehicle, is known from DE 44 27 196 A1. This device can be moved by an adjusting device from a retracted rest position into an extended operating position. To create a highly effective air guide device which takes up a minimum of space in its rest position, it is provided that the air guide device can be retracted and extended in the height direction of the vehicle and, when in the operating position, is connected over its entire transverse dimension to the underlying structure in an air-impermeable manner and also projects above this structure.

Finally, an air guide device for guiding an air stream on a motor vehicle is known from DE 10 2004 043 544 A1. To prevent the air from flowing underneath a spoiler blade and at the same time to be able to carry away intruding water effectively, an underflow guard, which prevents air from flowing underneath the spoiler blade, and a water guide device, which carries away the water coming from the spoiler blade or present in its environment, are provided as integral parts of the spoiler blade.

The present invention deals with the problem of providing, for an air guide device of the general type in question, an improved or at least a different embodiment, which is highly effective when in the extended operating position.

This problem is solved according to the invention by the objects of the independent claims. Advantageous embodiments are the object of the dependent claims.

The invention is based on the general idea, in the case of an air guide device with a flow element designed as an underflow guard and an adjustable air guide element such as a spoiler blade, to provide a sealing element, which seals off an intermediate space between the air guide element and the flow element at least when the air guide element is fully extended. This reliably prevents the undesirable flow of air underneath the air guide element and thus increases its effectiveness. A sealing element of this type can be designed, for example, as a low-cost plastic part produced by the injection-molding process. The desired elasticity can be determined in advance by a defined material selection. Because the sealing element is designed to be flexible, it is able to conform easily to different adjustment states of the air guide device.

It is advisable for the sealing element to comprise stiffening elements, especially stiffening ribs. These stiffening elements can be formed by areas of thickened material, for example, or by intermediate layers, which are embedded into the sealing element made of plastic. In particular, these intermediate layers can be embedded as part of the injection-molding process.

Other important features and advantages of the invention can be derived from the subclaims, from the drawings, and from the associated description of the figures, which are described on the basis of the drawings.

It should be obvious that the features cited above and yet to be explained below are applicable not only when combined as specifically stated but also in other combinations as well or even when used alone without leaving the scope of the present invention.

A preferred exemplary embodiment of the invention is illustrated in the drawing and is explained in greater detail in the following description.

The single FIGURE shows a transverse section of the inventive air guide device in its operating position.

As shown in the FIGURE, an inventive air guide device 1 comprises an adjustable air guide element 2 and at least one, also adjustable, flow element 3, designed as an underflow guard. The air guide element 2 can be designed, for example, as a spoiler blade, and thus bring about the actual air-guiding action and thus the downforce on the motor vehicle and/or a reduction of the air resistance. In general, the air guide device 1 can be arranged in the rear area of a motor vehicle and in particular between a rear edge, with respect to the travel direction 4, of a rear window 5 and a forward edge of a trunk lid 6. The air guide device 1 can be arranged on the trunk lid 6, preferably in the center. The air guide device 1 or its air guide element 2 can be adjusted between a rest position and one or more operating positions. In its operating position, the air guide device 1 generates a downforce, which helps to improve the vehicle's grip on the road, and/or a change, especially an improvement, in the so-called cw value, preferably a reduction in the air resistance.

To prevent effectively the undesirable flow of air underneath the air guide element 2, the flow element 3 is provided, which, when the air guide device 1 is in its operating position, rests on the air guide element 2. So that it is also possible for the air guide device 1 to occupy only a small amount of space especially when in the rest position, the flow element 3 is connected to the air guide element 2 by an adjusting mechanism, which can be designed, for example, as a lever mechanism. This adjusting mechanism makes it possible for the air guide device 1 to be stowed compactly in its rest position, in which it rests, for example, in a body well 8, which is only suggested in the FIGURE. In this stowed state, the flow element 3 lies just underneath the air guide element 2.

As can also be seen in the FIGURE, when the air guide element 2 is extended, the forward edge, with respect to the direction of travel, of the minimum of one flow element 3 adjoins a body of the motor vehicle, here a rear window 5 of the vehicle, so that it is possible preferably to prevent any undesirable flow of air at all through the body well 8. It can also be derived from the FIGURE that the air guide element 2 carries a sealing element 9 on its forward edge with respect to the travel direction 4, especially a sealing lip. Of course, it is also conceivable that the sealing element 9 could be on the rear edge of the flow element 3 rather than on the forward edge of the air guide element 2.

The FIGURE shows several different extension states A1, A2, and A3 of the air guide element 2. Each of these can correspond to an operating position, or the air guide element can pass through each of these as it moves into the operating position, where, however, common to all of these extension states A1, A2, A3 and possibly also to the operating position, is the fact that the sealing element 9 rests tightly on the flow element 3 and thus seals off the transition area between the air guide element 2 and the flow element 3, as a result of which the undesirable flow of air underneath the air guide element 2 is prevented or reduced. The double arrow DP indicates how the sealing element 9 is positioned along the flow element 3, depending on the extension state A1, A2, A3 or operating position relative to the flow element.

The sealing element 9 can comprise stiffening elements, especially stiffening ribs, to stiffen it. These can be formed by areas of thicker material, for example, or by stiff intermediate layers. These stiffening elements are intended to ensure in particular that the sealing element 9 lies tightly against the flow element 3 and thus offers effective flow protection. The sealing element 9 can be designed as a low-cost plastic element.

The sealing element 9, as shown in the FIGURE, is attached by its fastening section 7, whereas it rests by its sealing section 10 on the flow element 3. It is also conceivable that an additional sealing element (not shown) could be provided between the flow element 3 and the rear window 5 to prevent the undesirable flow of air between the flow element 3 and the rear window 5. Common to all of the sealing elements 9, however, is that they preferably produce a sealing action between the air guide element 2 and the flow element 3 regardless of the extent to which the air guide element 2 is extended.

1.-9. (canceled)

10. An extendable and retractable air guide device for a motor vehicle comprising:
an adjustable air guide element; and
at least one adjustable flow element designed as an underflow guard, wherein a sealing element, which seals off an intermediate space between the air guide element and the flow element at least when the air guide element is fully extended, is positioned either on the air guide element or on the flow element.

11. An air guide device according to claim 10, wherein the sealing element is arranged on an edge of the flow element which faces toward a rear of the vehicle, with respect to a travel direction of the vehicle, or on an edge of the air guide element which faces forward with respect to the travel direction of the vehicle.

12. An air guide device according to claim 10, wherein the sealing element is designed as an elastic sealing lip.

13. Air guide device according to claim 10, wherein when the air guide element is extended, a forward edge of at least one flow element adjoins a body of the motor vehicle.

14. An air guide device according to claim 13, wherein when the air guide element is extended, a forward edge of at least one flow element adjoins a rear window of the vehicle.

15. An air guide device according to claim 10, wherein the sealing element comprises stiffening elements.

16. An air guide device according to claim 15, wherein the stiffening elements comprise stiffening ribs.

17. An air guide device according to claim 10, wherein the sealing element comprises a fastening section and a sealing section designed as an integral part of the fastening section.

18. An air guide device according to claim 10, wherein the sealing element extends over an entire width of the air guide element and/or an entire width of the flow element.

19. An air guide device according to claim 10 further comprising another sealing element positioned between a rear window of the vehicle and the flow element.

20. A motor vehicle with an air guide device according to claim 10.

21. An air guide device according to claim 10, wherein the air guide device is a rear spoiler.
